(19) United States
(12) Patent Application Publication
(10) Pub. No.: US 2015/0047493 A1
(43) Pub. Date: Feb. 19, 2015

(54) Automatic Tuning Devices and Methods

(71) Applicant: CLAIR PRICE LTD, Somerset (GB)

(72) Inventors: Andrew Mark Leadbetter, Somerset (GB); David Martyn Googway, Somerset (GB); Richard John Whittall, Somerset (GB)

(21) Appl. No.: 14/386,556

(22) PCT Filed: Mar. 21, 2013
(86) PCT No.: PCT/GB2013/050745

§ 371 Date: Sep. 19, 2014

(30) Foreign Application Priority Data
Mar. 21, 2012 (GB) 1204975.5

(51) Int. Cl. G10G 7/02; G10H 3/18

(52) U.S. Cl. CPC G10G 7/02; G10H 3/186
USPC 84/454

(57) ABSTRACT

An automatic tuning device for a musical instrument, the device comprising: an automatic tuning mechanism which is configured to tune a musical instrument in accordance with a tuning configuration, wherein the mechanism includes: a processor configured to execute a computer program, a memory configured to store one or more computer programs for execution by the processor, and a communication interface configured to receive one or more computer programs for storage in the memory, wherein the one or more computer programs include a computer program which, when executed by the processor, controls an aspect of the operation of the automatic tuning device.

### DESCRIPTION OF INVENTION

Embodiments of the present invention relate to devices and methods for use the automatic tuning of a musical instrument. In particular, embodiments of the present invention relate to devices and methods for use in the automatic tuning of a stringed instrument—such as a guitar.

Devices for automatically tuning instruments are known. A device for automatically tuning a guitar, for example, is known from U.S. Pat. No. 6,415,584 (WO99/46757). The device disclosed in U.S. Pat. No. 6,415,584 represented a significant advance in the development of devices for assisting a user tune a guitar or other stringed instrument.

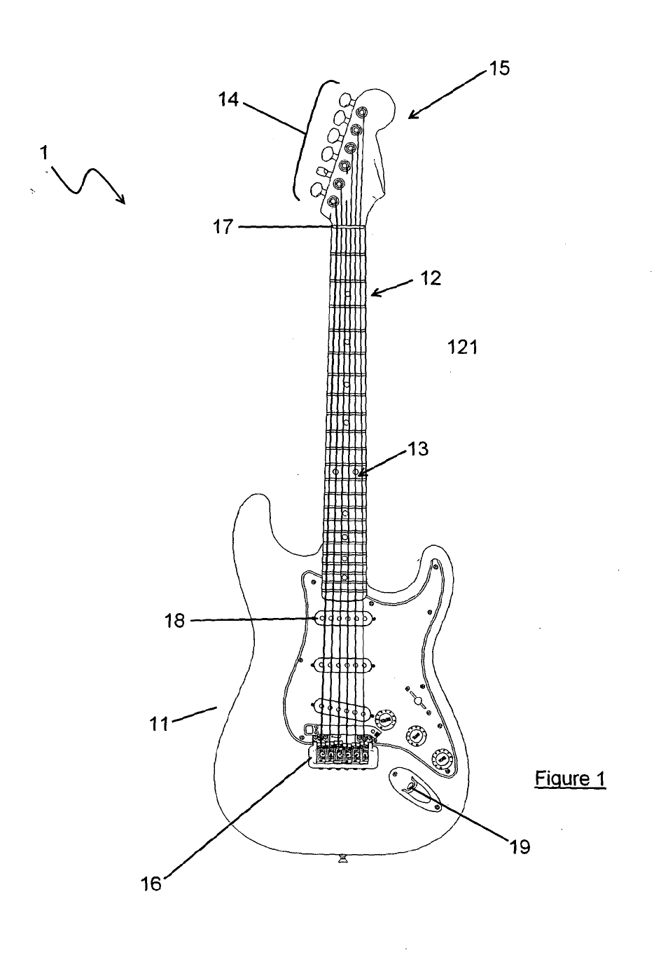

A conventional guitar 1 is, for ease of reference, shown in FIG. 1. A guitar 1 typically comprises a body 11 and a neck 12. The neck 12 and body 11 are coupled together and a head 15 of the guitar 1 is located at an end of the neck 12 which opposes the body 11 of the guitar 1 across a length of the neck 12. A plurality of strings 13 is provided wherein each string 13 is coupled at a first end to the head 15 and at a second end to the body 11 such that the plurality of strings 13 extends along a length of the neck 12 and over a fret board 121 mounted on the neck 12

The first end of each string 13 is typically attached to a tuning peg 14 at the head 15 of the guitar 1. When the strings 13 are fitted to the guitar 1, each string 13 is conventionally held against a ridge (or “nut”) 17 located generally between the head 15 and the neck 12 of the guitar 1.

The second end of each string 13 is typically coupled to the body 11 of the guitar 1 through a bridge 16.

The plurality of strings 13 is tensioned between the bridge 16 and the ridge 17.

A sound produced by a musical instrument is typically considered to be formed from two elements, a note (or pitch) and a quality which is a characteristic of the instrument. A note has a particular fundamental sound frequency and the quality which is a characteristic of the instrument may include a complex mixture of harmonic sound frequencies dependent on, for example, the nature of the instrument and the relevant fundamental sound frequency. The fundamental sound frequency is dependent on the resonant frequency of the part of the instrument which vibrates to produce the sound.

As will be appreciated, therefore, the resonant frequency of a string determines the fundamental sound frequency produced when that string is played.

The resonant frequency of a string of a guitar depends on, for example, the material from which the string is formed, the tension of the string, and the length of the string.

The length of each string 13 between the bridge 16 and the ridge 17 represents the tuned length of the string (i.e. the length of the string 13 which oscillates to produce the note). During conventional manual tuning, the tuned length of each string 13 remains substantially constant (along with the material from which the string 13 is formed) and the tension of the string 13 is adjusted to alter the resonant frequency of the string 13 to tune the guitar 1.

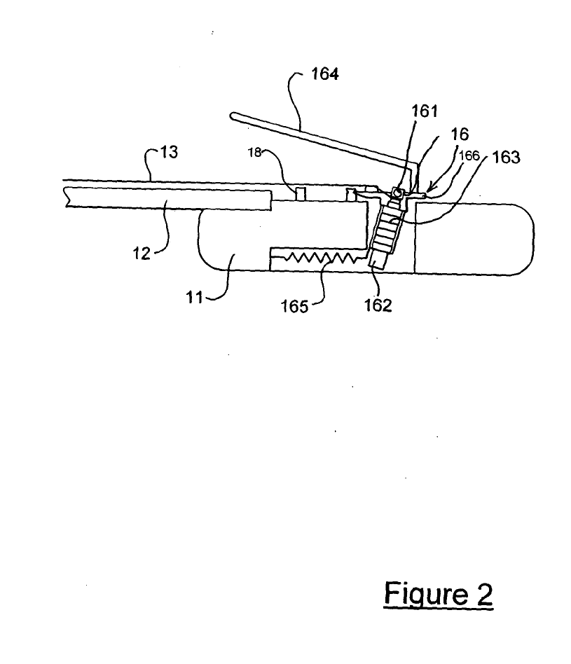

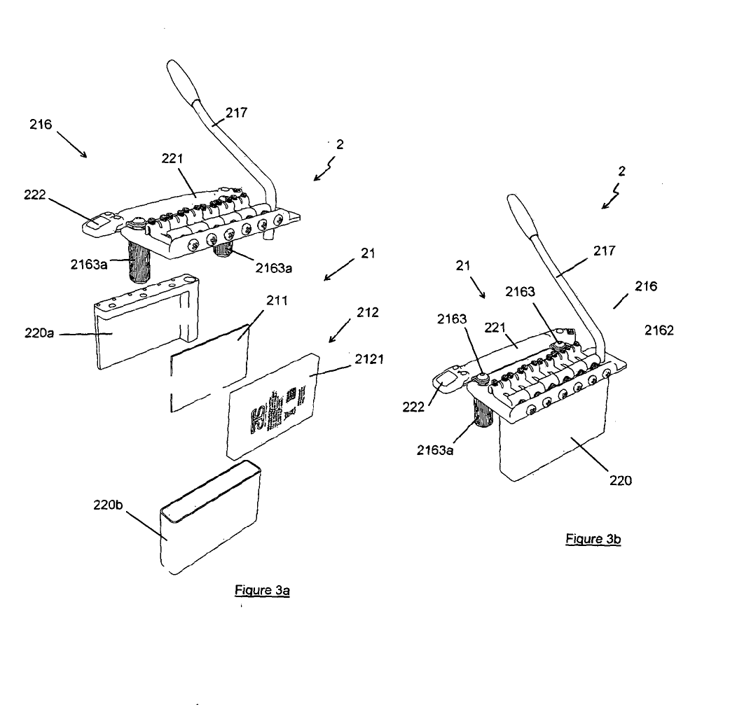

The innovative device disclosed in U.S. Pat. No. 6,415,584 comprises a modified bridge 16 in which each string 13 is coupled to a rotatable spindle 161 (see FIG. 2) such that rotation of the spindle 161 in a first direction increases the tension of the string 13 and rotation of the spindle 161 in a second (opposing) direction decreases the tension of the string 13. Each spindle 161 is coupled to a motor 162 through a gearbox 163. Each motor 162 is configured to drive rotation of the associated spindle 161 in the first and second directions.

Each motor 162 is in electrical communication with a drive and control circuit (not shown in FIG. 2) which controls operation of the motor 162.

The drive and control circuit is also coupled to a pick-up 18 of the guitar 1 which is configured to output an electrical signal representative of the vibration of an adjacent string 13. A single pick-up 18 may be provided which includes a plurality of pick-up elements (not shown in FIG. 2) such that the pick-up 18 outputs a corresponding number of electrical signals wherein each electrical signal is associated with one string 13.

Thus, the tension of each string 13 may be adjusted automatically to tune the guitar 1 by the drive and control circuit causing each motor 162 to drive rotation of the associated spindle 161 (through each gearbox 163) based on signals received in association with that string from the pick-up 18.

The modified bridge 16 shown in FIG. 2 includes a vibrato handle 164, a pivotably mounted bridge plate 166 and a resilient biasing mechanism 165 as is known in the art.

For the avoidance of doubt, the entire content of U.S. Pat. No. 6,415,584 and WO 99/46757 is incorporated herein by reference.

Prior art automatic tuning devices can be used to tune a guitar. However, prior art automatic tuning devices lack any additional abilities. There is a need, therefore, to ameliorate one or more problems associated with the prior art.

Accordingly, an aspect of the present invention provides an automatic tuning device for a musical instrument, the device comprising: an automatic tuning mechanism which is configured to tune a musical instrument in accordance with a tuning configuration, wherein the mechanism includes: a processor configured to execute a computer program, a memory configured to store one or more computer programs for execution by the processor, and a communication interface configured to receive one or more computer programs for storage in the memory, wherein the one or more computer programs include a computer program which, when executed by the processor, controls an aspect of the operation of the automatic tuning device.

The communication interface may be a wireless communication interface.

The communication interface may be a wired communication interface.

The wired communication interface may be configured to couple communicatively the mechanism to an external device.

The device may be for a guitar.

The one or more programs may include a tuning configuration.

The device may further comprise a pick-up which is configured to output a signal representative of the vibration of an associated string of the instrument.

The mechanism may be configured to use the signal output by the pick-up in a tuning process.

The communication interface may be configured to couple communicatively the mechanism to a catalogue of one or more computer programs, each of which is downloadable to the mechanism for storage in the memory.

The one or more computer programs of the catalogue of one or more computer programs may include a collaborative computer program which is configured to allow collaborative works to be generated by multiple devices; and/or a tutorial computer program; and/or a game.

The communication interface may be configured to receive one or more computer programs when the mechanism is in a fitted configuration with respect to the instrument.

The communication interface may be configured to output information regarding the operation of the instrument.

The information may include real-time or substantially real-time information.

The information may include an audio output signal for the instrument.

The information may include historical usage information.

The information may include a substantially unique identifier for the device.

Another aspect of the present invention provides a system including a device as above and an external device which is communicatively coupled to the device by the communication interface.

The external device may include an amplifier.

The communication interface may be configured to output a digital audio signal to the external device.

The external device may be configured to receive the digital audio signal, transform the digital audio signal, and transmit the transformed digital audio signal to a further device.

The external device may be configured to receive the digital audio signal, transform the digital audio signal, convert the transformed digital audio signal into an analog audio signal and transmit the analog audio signal to a further device.

The transformation of the digital audio signal may include the application of an audio effect.

The external device may be a wireless communication module device.

Another aspect of the present invention provides a computer program distribution system comprising: a catalogue of one or more computer programs; and a communication interface configured to be communicatively coupled to a device as above, wherein the system is configured to transmit a computer program of the one or more computer programs to the device and the computer program, when executed by the processor of the device, controls an aspect of the operation of the device.

Another aspect of the present invention provides a portable storage medium on which is stored a computer program in a computer readable format, wherein the medium is configured to be coupled to a device as above, and the computer program, when executed by the processor, controls an aspect of the operation of the device.

Another aspect of the present invention provides a diagnostics system comprising: a communication interface configured to be communicatively coupled to a device as above and to receive information therefrom; and an analysis module configured to analyse the received information to identify one or more faults with the device, and/or to make one or more recommendations in relation to the operation of the device or the instrument to which the device is fitted.

Another aspect of the present invention provides a musical instrument to which a device as above is fitted.

Aspects and embodiments of the present invention are described herein with reference to the accompanying drawings, by way of example only, in which:

FIG. 1 shows a view of a conventional guitar;

FIG. 2 shows a prior art automatic tuning device; and

FIG. 3a shows a partially exploded view of the embodiment of FIG. 3b;

FIG. 3b shows an embodiment;

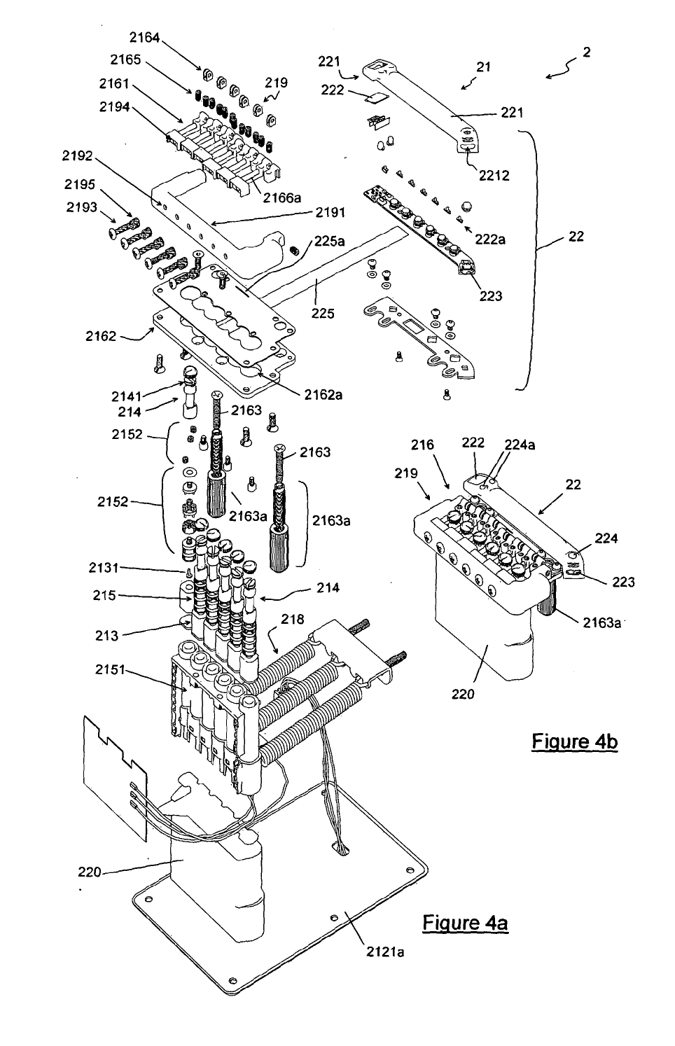

FIG. 4a shows a partially exploded view of the embodiment of FIG. 4b;

FIG. 4b shows an embodiment;

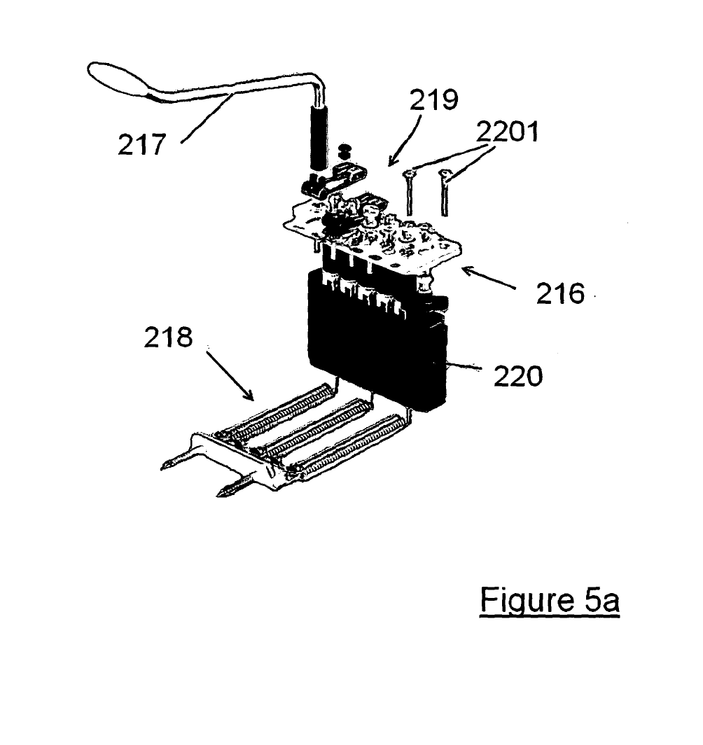

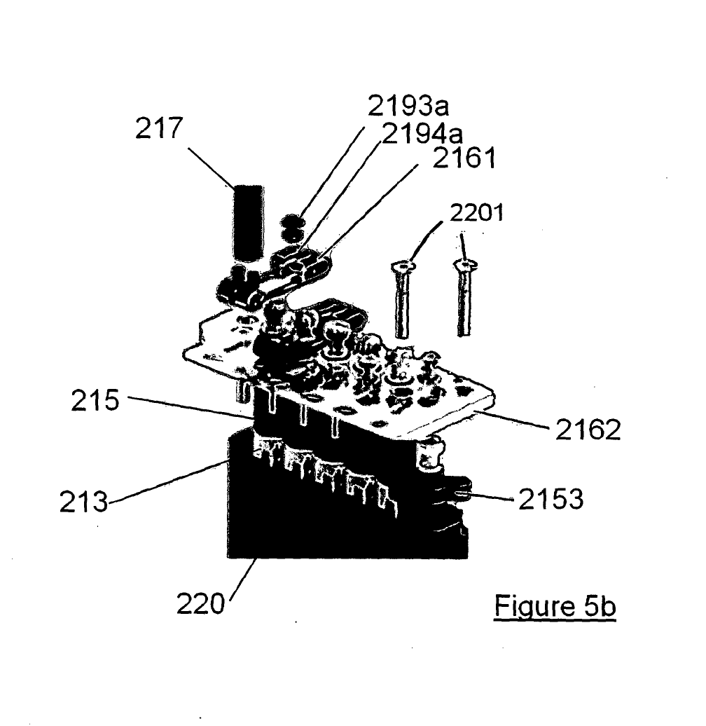

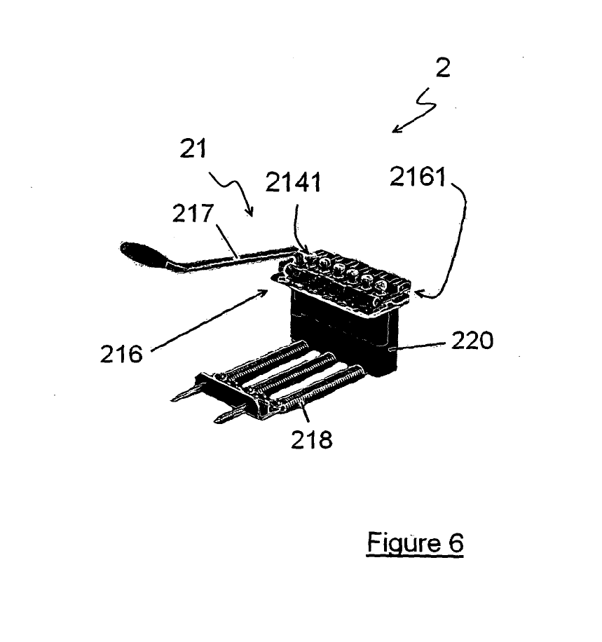

FIGS. 5a, 5b, and 6 show different views of substantially the same embodiment (wherein a part of the housing in FIG. 6 is cutaway for clarity);

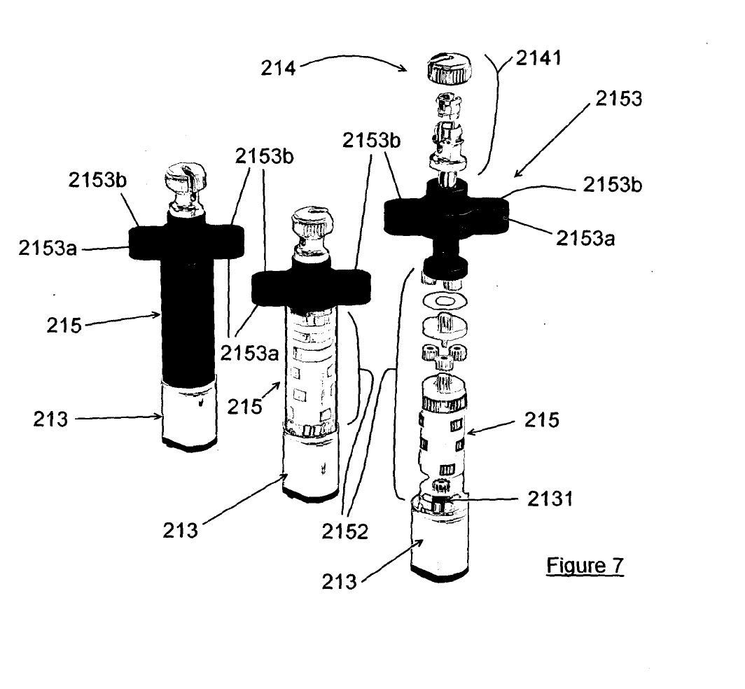

FIG. 7 shows three different views of aspects of embodiments of a gearbox and other features (wherein a part of the housing in the central view is transparent for clarity);

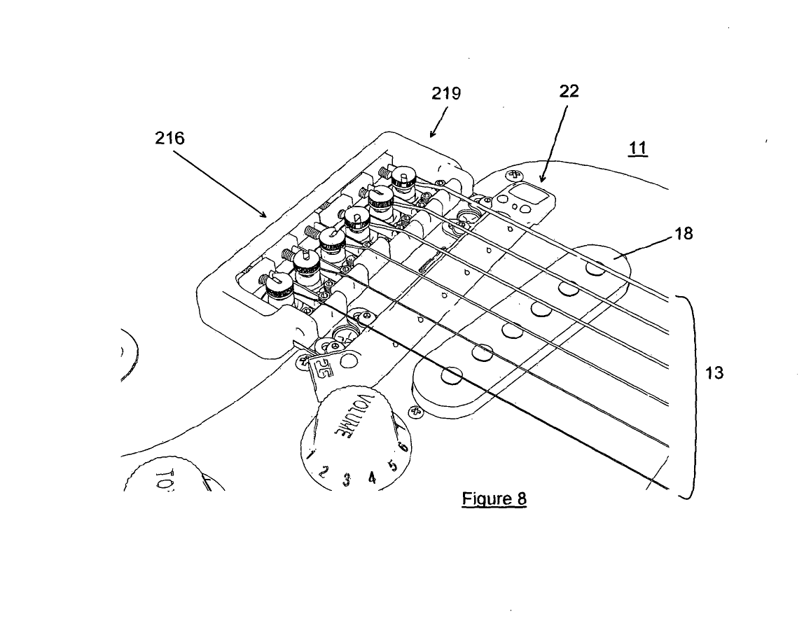

FIG. 8 shows an embodiment without a vibrato;

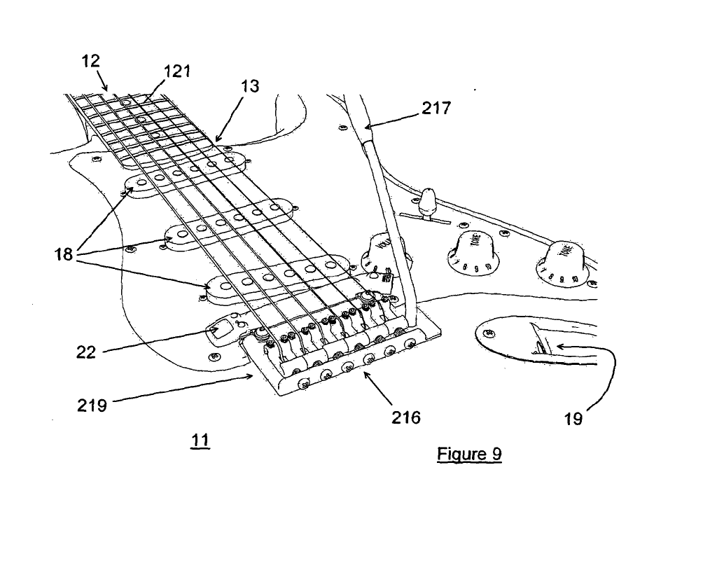

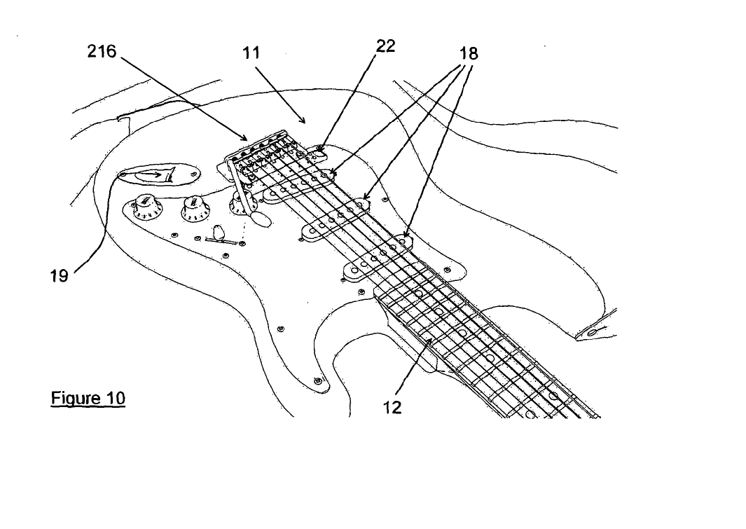

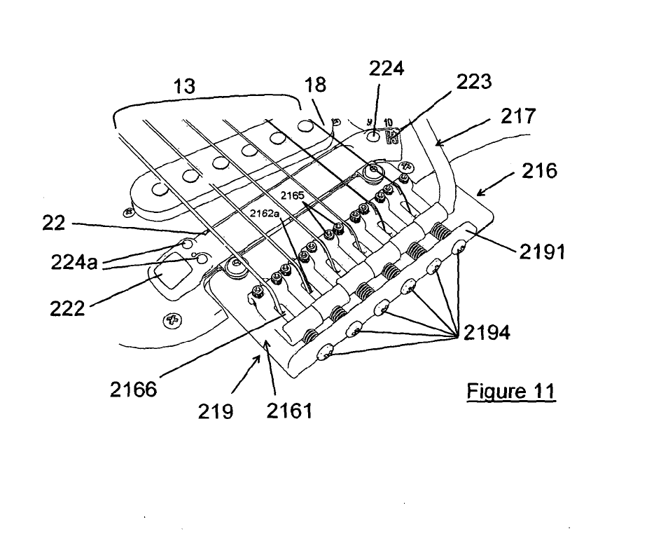

FIGS. 9, 10, and 11 shows an embodiment with a vibrato;

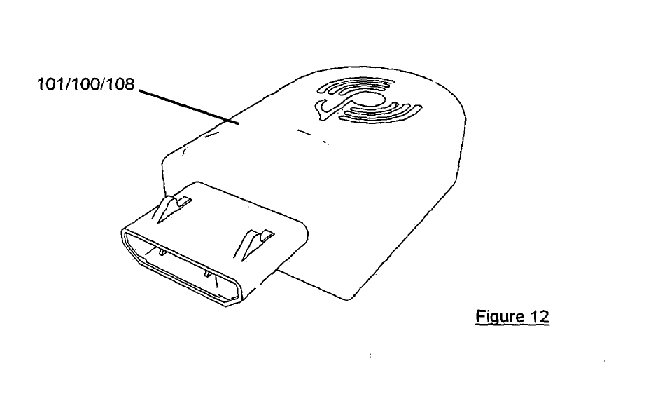

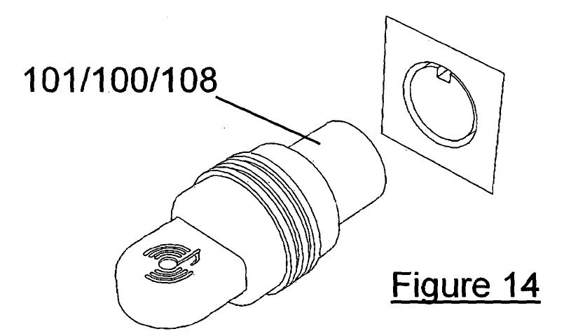

FIGS. 12 and 14 show devices which may be the form taken by several different devices described herein;

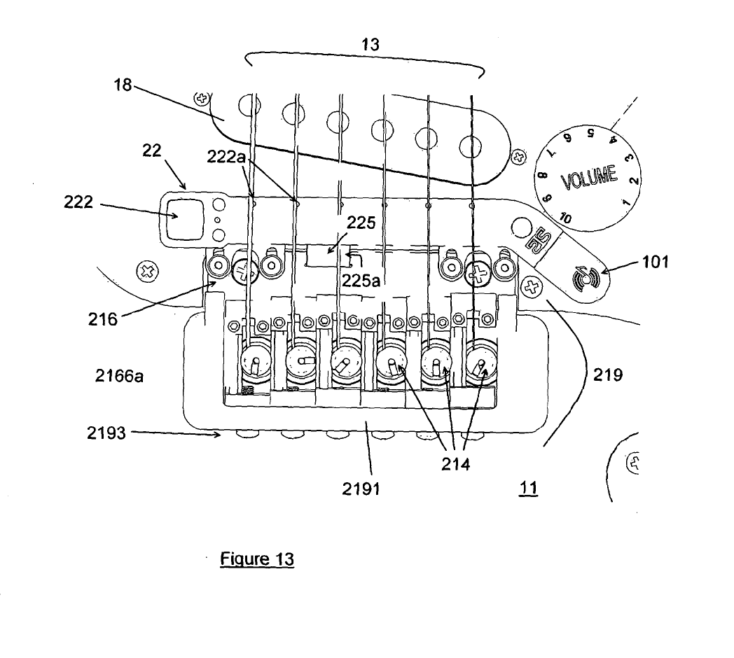

FIG. 13 shows an embodiment without a vibrato and with an external device connected to the connector of the pick-up;

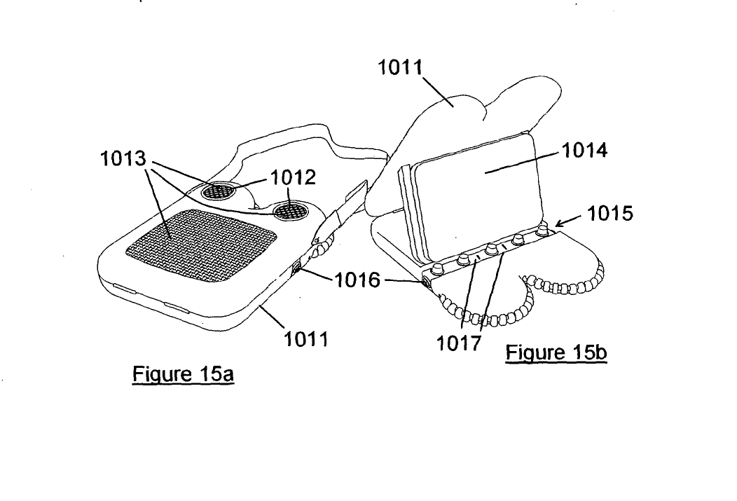

FIGS. 15a and 15b show an external device of embodiments;

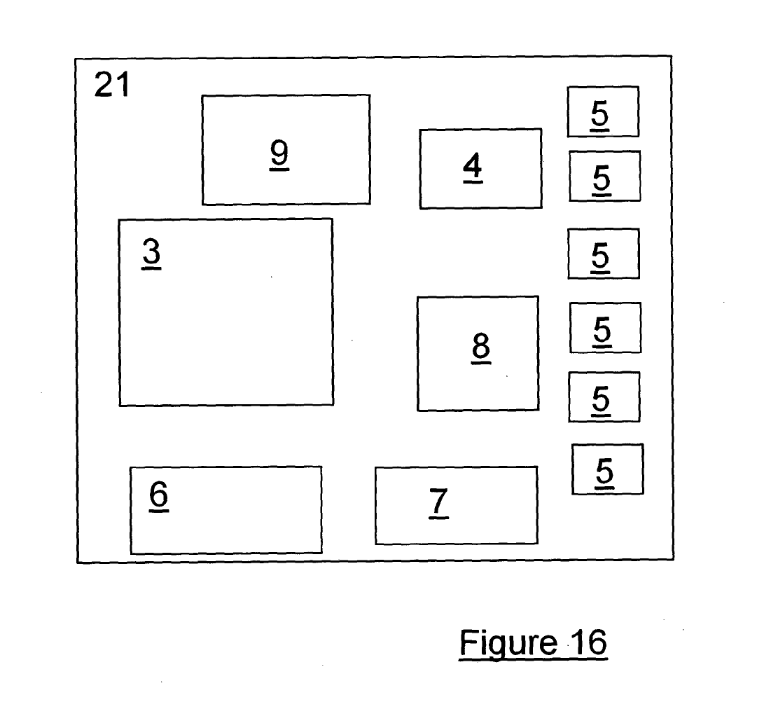

FIG. 16 shows a schematic view of a drive and control circuit of embodiments; and

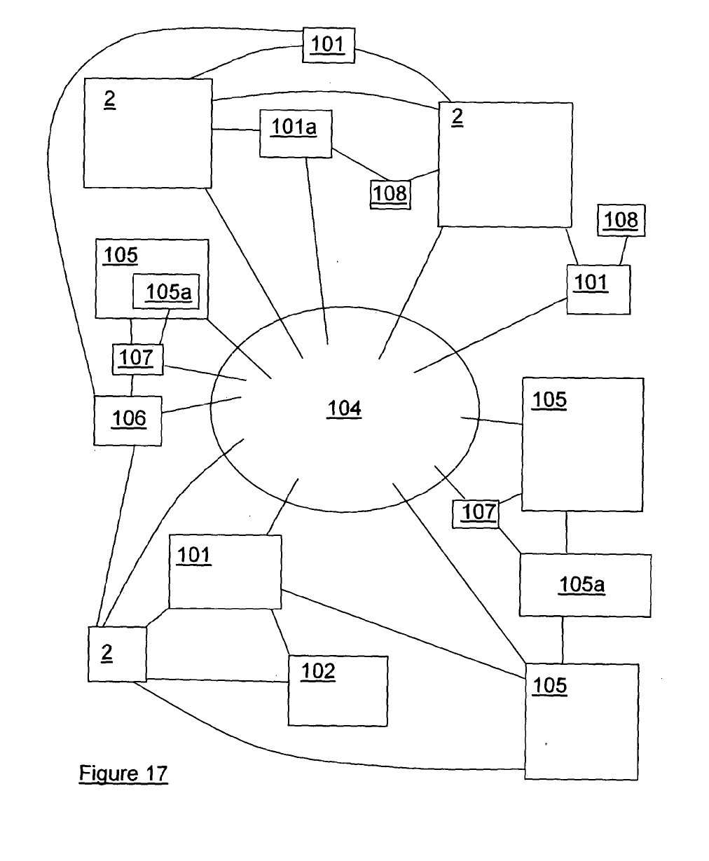

FIG. 17 shows example interconnected components of a system of embodiments.

With reference to FIGS. 3 to 11 and 13, embodiments of the present invention include a device 2 with an automatic tuning mechanism 21 which operates in a manner which is comparable to the mechanism discussed above in relation to FIGS. 1 and 2.

The device 2 is configured to be fitted to a stringed instrument such as a guitar 1 but may be fitted to other instruments with appropriate modifications to the automatic tuning mechanism 21. For ease of reference, therefore, embodiments of the invention are described with reference to a guitar 1 such as the guitar depicted in FIG. 1.

The automatic tuning mechanism 21 includes a drive and control circuit 211 which is electrically coupled to a power supply 212 and which is configured to control the operation of a plurality of motors 213 through an electrical coupling therewith.

Each of the plurality of motors 213 is mechanically coupled to a respective spindle 214 through a gearbox 215. Each spindle 214 is configured for coupling to a first end of a string 13.

The operation of each motor 213, gearbox 215, and spindle 214 is substantially as described above in relation to FIGS. 1 and 2. Accordingly, rotation of a spindle 214 will cause an increase or decrease in the tension of a string 13 (of the guitar 1) coupled thereto depending on the direction of rotation such that the resonant frequency of the string 13 can be adjusted by rotation of the spindle 214 to tune the guitar 1.

It will be appreciated that the automatic tuning mechanism 21 is part of a bridge 216 of the guitar 1.

The bridge 216 may be a vibrato bridge (including a coupling for a vibrato handle 217, a vibrato handle 217, and a resilient biasing mechanism 218). Accordingly, the bridge 216 may include a bridge plate 2162 which is mounted to the body 11 of the guitar 1 in a pivotable manner. The mounting of the bridge plate 2162 to the guitar body 11 is such that a part of the bridge 216 on which the strings 13 bear is rotationally moveable with respect to a part of the body 11 of the guitar 1 about a pivot. The mounting is, in the depicted embodiment, achieved with two threaded attachment members 2163. Each threaded attachment member 2163 may be received by a correspondingly threaded aperture in the body 11 of the guitar 1 or, for example, received by a correspondingly threaded aperture in a pin 2163a which is configured to be received by a correspondingly shaped aperture in the body 11 of the guitar 1. The bridge plate 2162 may abut against the two threaded attachment members 2163 to form the pivot.

The bridge 216 may also include a saddle 2161 for each respective string 13. Accordingly, when fitted to the guitar 1, each string 13 may bear against a respective saddle 2161 of the bridge 216. The saddles 2161 may be attached to the bridge 216 such that each string 13 passes over a respective saddle 2161 between the spindle 214 and the ridge 17 of the guitar 1. Each saddle 2161 may be moveable along an axis of the associated string 13 in order to allow minor adjustments to the tuned length of the string 13 (conventionally known as “intonation adjustments”)—the tuned length being, more specifically, the distance between the ridge 17 and the surface of the saddle 2161 of the bridge 216 against which the string 13 bears.

In embodiments, each saddle 2161 includes a bearing member 2164 against which a string 14 will bear in use. The bearing member 2164 may comprise a roller which is rotatable with respect to body 11 of the guitar 1 (and another part of the bridge 216). In other embodiments, such as the depicted embodiment of FIGS. 3, 5, 6, 8, 9, 10, and 11, the bearing member 2164 includes an “n” shaped portion of the saddle 2161 over which the string 14 will bear. The bearing member 2164 may include a pair of protrusions 2165 towards the respective sides thereof such that the string 14 will bear against a surface of the bearing member 2164 between the pair of protrusions 2165—the protrusions 2165 reducing the likelihood of the string 14 moving over the side edges of the bearing member 2164 such that it no longer bears against the correct part of the bearing member 2164. The pair of protrusions 2165 may comprise, for example, threaded members which are fitted to threaded apertures through a surface of the bearing member 2164. Accordingly, the height of extension of each protrusion above the adjacent surface of the bearing member 2164 may be adjustable by rotation of the threaded members in the threaded apertures—in some embodiments.

The bearing member 2164 may include a groove therein to receive, at least partially, a string 14 passing thereover.

The bearing member 2164 may include a coating to improve the wear characteristics of the saddle 2161—as will be appreciated, the strings 13 will move linearly with respect to the saddle 2161 far more than would be the case for a conventional (manually tuned) guitar. The coating may be a diamond based coating. The bearing member 2164 may be, for example, treated with a multiplex laser surface enhancement treatment.

In embodiments, each saddle 2161 includes an elongate aperture 2166 which is generally aligned with an aperture 2162a in the bridge plate 2162 through which a string 14 may pass—there being such an aperture 2162a for each saddle 2161 and there being a saddle 2161 for each string 14.

In embodiments, at an end of the saddle 2161 which is remote from the bearing member 2161 is an intonation adjustment mechanism 219 which comprises an end plate 2191 which is immovably fixed to the bridge plate 216 and which may be integrally formed therewith. In embodiments, the end plate 2191 extends in a direction substantially perpendicular to the bridge plate 216 (and away from the body 11 of the guitar 1).

The end plate 2191 includes an unthreaded aperture 2192 for each string 14 of the guitar 1. The unthreaded apertures 2192 are generally aligned with respective saddles 2161. Respective threaded adjustment members 2193 are configured to pass through each unthreaded aperture 2193 and into a threaded adjustment aperture 2194 in each saddle 2161. Respective resilient biasing mechanisms 2195 may be positioned between adjacent surfaces of the end plate 2191 and each saddle 2161 to bias the saddles 2161 away from the end plate 2191. The resilient biasing mechanisms 2195 may comprise helical springs and the threaded adjustment members 2193 may each pass through each resilient biasing mechanism 2195. The threaded adjustment members 2193 are provided with heads which prevent the threaded adjustment members 2193 from passing though the unthreaded apertures 2192. The heads may be configured to fit with, for example, a screwdriver to allow rotation of the heads, and hence the threaded adjustment members 2193, to move the saddles 2161 towards or away from the end plate 2191 through interaction of the threads of the threaded adjustment members 2193 and the threads of the threaded adjustment apertures 2194.

It will be understood that other intonation adjustment mechanisms 219 and saddles 2161 are known and may be used in combination with other features of embodiments of the invention. For example, an alternative intonation adjustment mechanism 219 and saddle 2161 is shown in FIGS. 4 and 13. In this intonation adjustment mechanism 219 and saddle 2161, the bearing member 2161 is coupled by a bar 2166a to the opposing end of the saddle 2161 and the spindles 214 extend through the apertures 2162a in the bridge plate 2162 such that they are at least partially located on a side of the bridge plate 2162 which opposes the body 11 of the guitar 1.

In other embodiments, see FIGS. 5 and 6 for example, the elongate aperture 2166 in the saddle 2161 includes a widened portion through which the spindle 214 may extend.

The intonation adjustment mechanism 219 may include a slot 2194a in the saddle 2161 which is configured to receive a threaded locking member 2193a which is moveable (by rotation) between a position in which the threaded locking member 2193a bears against a surface of the bridge plate 2162 to prevent substantial movement of the saddle 2161 with respect to the bridge plate 2162 and another position in which the threaded locking member 2193a does not bear against this surface and the saddle 2161 is moveable with respect to the bridge plate 2162—such that the saddle 2161 can be positioned with respect to the bridge plate 2162 and then locked into position by the threaded adjustment member 2193a.

Each spindle 214 is, as mentioned above, mechanically coupled to a respective motor 213 via a respective gear box 215. The gear box 215 may be of similar construction to the gearbox 163 discussed above in relation to FIGS. 1 and 2.

An embodiment of a suitable gearbox 215 is shown in FIG. 7. The gearbox 215, in this depicted embodiment, includes a tubular housing 2151 and a plurality of gears 2152 which are configured to convert the relatively fast rotation of a shaft 2131 of a motor 213 to a slower rotational speed of the spindle 214. The friction within the gearbox 215 substantially prevents backdriving of the motor 213 through rotation of the spindle 214—under normal operating conditions.

The gearbox 215 is, in this embodiment, mounted on the motor 213 and includes a mounting structure 2153 which is located between the motor 215 and the spindle 214. In this embodiment, the mounting structure 2153 includes one or more (two in the depicted example) mounting arms 2153a which each include respective apertures therethrough 2153b. The mounting arm or arms 2153a may extend radially away from a central longitudinal axis of the gearbox 215. Two arms 2153a may be diametrically opposed across the gearbox 215. The motor 213, tubular housing 2151 and mounting structure 2153 are preferably coupled together in a rotationally immoveable manner.

The spindle 214 may include a spindle head 2141 which includes a mechanism for holding or otherwise securing a string 13 thereto such that rotation of the spindle 214 will cause an increase or decrease in the string 13 tension.

With reference to FIGS. 4, 5, and 6 for example, in embodiments, parts of the automatic tuning mechanism 21 are housed in a housing 220 which is received by the body 11 of the guitar 1.

The housing 220 may include a cavity for receiving a circuit board 2111 and one or more other components of the drive and control circuit 211. In embodiments, the power supply 212 includes a battery 2121 (which may be a rechargeable battery) which is also housed within a cavity of the housing 220. In embodiments, the battery 2121—if provided—may be integrated into a rear cover plate 2121a of the guitar 1 and connected by wires to one or more other components of the drive and control circuit 211.

In embodiments, a first part of the housing 220a comprises an insert and top section which at least partially define a volume which is sized to receive one or more components of the drive and control circuit 211 and power supply 212—for example, the circuit board 2111 and the battery 2121. The first part of the housing 220a is configured, in this embodiment, for insertion into a box forming a second portion 220b of the housing 220.

The housing 220 (and, if provided, the first part of the housing 220a) may be configured for attachment to the bridge plate 2162 by one or more attachment members such as threaded attachment members (not shown).

In embodiments, the housing 220 is also configured to receive at least part of each motor 213. In embodiments, the housing 220 is also configured to receive at least part of each gearbox 215.

In embodiments, the mounting structure 2153 of each gearbox 215 may be configured to mount the gearbox 215 to the bridge plate 2162 and/or the housing 220 using one or more attachment members such as a threaded attachment member 2201.

In embodiments, not all gearboxes 215 are mounted in this manner. In embodiments, only some of the gearboxes 215 are mounted in this manner. In embodiments, the threaded attachment member 2201 extends through the bridge plate 2162 through the aperture 2153b in the arm 2153a of the mounting structure 2153 and into the housing 220, to connect these components together.

The housing 220 may include a structure to attach the housing 220 to a resilient biasing mechanism 165 of a vibrato system.

The automatic tuning mechanism 21, and specifically the drive and control circuit 211 may be in electrical communication with a pick-up 18 of the guitar 1 such that the drive and control circuit 211 receives a signal from the pick-up 18 representative of the vibrations of one or more associated strings 13. The pick-up 18 is, in this embodiment, a factory fitted pick-up of the guitar 1 which is used by the guitar 1 to generate an analog (or digital) audio output signal which may be transmitted to an amplifier, for example.

In embodiments, the device 2 includes one or more of its own pick-ups 22.

The one or more pick-ups 22 may be attached to the bridge 216, may form part of the bridge 216, or may be unattached to the bridge 216 (in which case the or each pick-up 22 may be mounted to the body of the guitar 1).

The one or more pick-ups 22 are preferably housed in an elongate housing 221 which is configured to be mounted such that the or each pick-up 22 has a longitudinal axis which is perpendicular to the longitudinal axis of the strings 13—although other arrangements are possible. The or each pick-up 22 includes one or more pick-up elements (not shown) which are each configured to output an electrical signal representative of a vibration of an associated string 13.

At a first end 2211 of the elongate pick-up housing 221 is a display screen 222 and at a second end 2212 is a connector 223 suitable for coupling to an external device 101.

The or each pick-up 22, the display screen 222, and the connector 223 are all in electrical communication with the drive and control circuit 211. As such, a ribbon or other form of connection element 225 may extend from the or each pick-up housing 221 to the drive and control circuit 211—the connection element 225 being configured to transmit electrical signals between the or each pick-up 22, the display screen 222, the connector 223, and the drive and control circuit 211. The connection element 225 may pass through an aperture 225a in the bridge plate 2162.

As will be appreciated, in embodiments, the bridge 216 including the housing 220 and the or each pick-up 22, may be configured to be moveable (about the pivot) with respect to the body 11 of the guitar 1—on operation of the vibrato handle 164, for example.

The connector 223 may be a socket 223. The socket 223 may be configured to receive a universal serial bus (USB) (Type A or B), or a mini-usb (Type A or B), or a micro-usb (Type A or B) plug. The plug may be coupled to the external device 101 such that the connector 223 allows electrical communication between the external device 101 and the drive and control circuit 211.

The or each pick-up 22 may include a user input button 224 which is also in electrical communication with the drive and control circuit 211 (e.g. through the connection element 225). In embodiments, the user input button 224 is located substantially adjacent the connector 223.

In embodiments, a plurality of user input buttons 224 may be provided. The plurality may include, for example, one or more user input buttons 224a substantially adjacent the display screen 222.

In embodiments, a plurality of string displays 222a is provided as part of the pick-up 22. Each string display 222a is a display associated with a string 13 and is configured to display information regarding the associated string 13. In embodiments, each string display 22a is a light emitting diode which is configured to emit light (or light of a first colour) when the string 13 is tuned and not to emit light (or to emit light of a second colour) when the string 13 is not tuned. In embodiments, each string display 222a may be configured to display an indication (e.g. a emit light of a third colour) if the tuning of that string 13 is in progress or if an error has occurred (which may, in embodiments, be differentiated by the emission of light of a fourth colour or the intermittent emission of light of the first, second, or third colours, for example).

The string displays 22a may be located adjacent their respective associated strings 13 and may be below their respective associated strings 13 (or slightly offset therefrom to allow for easier viewing) when the guitar 1 is viewed in a plan position—as in FIG. 1).

The drive and control circuit 211 is described with reference to, for example, FIG. 16.

The drive and control circuit 211 (hereinafter the “circuit 211”) may include one or more components mounted on the circuit board 2111.

The circuit 211 includes a processor 3, one or more memory elements 4 which are configured to store data and/or instructions and to pass the data and/or instructions to the processor 3. The processor 3 and one or more memory elements 4 are, therefore, in electrical communication.

The circuit 211 may also include one or more band-pass filters 5 for use in processing one or more signals which are received from the or each pick-up 18,22 in the known manner. A band-pass filter 5 may be provided for each string 13. Each band-pass filter 5 may have an adjustable pass band.

The circuit 211 may also include one or more analog-to-digital converters 7 which are configured to convert respective signals received from the or each pick-up 18,22 (via a band-pass filter 5 or not) into a digital signal for use by the processor 3.

The processor 3, of course, may include its own caches, logic gates, and the like (not shown). The processor 3 may be a 24-bit or 32-bit processor and may be a Cortex-M4 processor from ARM Ltd.

In embodiments, the circuit 211 includes a power management module 8 which is configured to manage the distribution of electrical power from the power supply 212 to the other components of the device 2. In embodiments, the connector 223 is in electrical communication with the power management module 8 such that the power management module 8 is configured to receive electrical power from the connector 223 (transmitted thereto by the external device 101) and distribute the electrical power to the power supply 212 (for example, to recharge the battery 2121) and/or one or more other components of the device 2 for their own use.

As will be appreciated, the circuit 211 may be configured to operate in much the same manner as discussed above in relation to FIGS. 1 and 2.

The user input button 224 and/or buttons 224a may be used to input information into the circuit 211 such as the pitch to which a particular string 13 should be tuned to. The display screen 222 may display options for selection by the user (by actuation of the user input button 224 and/or buttons 224a) to control the operation of the circuit 211. The display screen 22 may also, for example, output an indication of the note currently being played.

In embodiments, the circuit 211 also includes a wireless communication module 6. The wireless communication module 6 is configured to be operated by the processor 3 and to transmit information wirelessly to another wireless device (which may be an external device 101—see FIGS. 12 and 14). The wireless communication module 6 may be configured to transmit information wirelessly over a radio-frequency communication channel. The wireless communication module 6 may be a Bluetooth or Wifi communication module. The communication protocol used by the wireless communication module 6 is preferably a digital communication protocol.

In embodiments, the circuit 211 is also configured to receive information from another wireless device (which may be an external device 101) through the wireless communication module 6.

In embodiments, the circuit 211 itself does not include the wireless communication module 6 but the module 6 is provided in a wireless communication module device 100 which is connectable to the connector 223. In such embodiments, the wireless communication module device 100 may have an independent power supply or the power management module 8 may direct electrical power from the power supply 212 (e.g. the battery 2121) to the wireless communication module device 100.

In embodiments, the wireless communication module 6 (whether provided as part of the circuit 211 or as part of a wireless communication module device 100) is configured to be paired with another wireless device (which may be an external device 101) which is separate from the device 2. The other wireless device may be permanently paired to the wireless communication module 6 such that the other wireless device cannot be paired with another wireless communication module 6 or the pairing may be configurable (such that the pairing can be configured and the other wireless device can be paired with other wireless communication modules 6). A paired wireless communication module device 100 and other wireless device may be provided with colour-coded markings to identify the pairing. In embodiments, a wireless communication module 6 can be paired to multiple other wireless devices and, in embodiments, an other wireless device can be paired to multiple wireless communication modules 6.

A paired wireless communication module 6 and other wireless device are configured to pass information therebetween. The pairing may be used to distinguish between information being wirelessly communicated by a plurality of wireless communication modules 6 (associated with a plurality of guitars 1, for example). The pairing may be achieved, for example, by the use of identifying codes for the wireless communication module 6 and other wireless device.

The other wireless device (or devices) may include, or may be connected to, an amplifier or computer. In other embodiments, the other wireless device is an amplifier or computer. In other embodiments, the other wireless device is another wireless communication module 6 of another circuit 211 of another guitar 1.

In embodiments, the other wireless device is what is conventionally known as a “dongle”—a wireless communication device which can be coupled to further device to provide that further device with wireless communication capabilities. The dongle may include a USB, micro-usb, or mini-usb (all Type A or B) connector to allow the dongle to be connected to an external device 101. The connector may also be a connector which is conventionally used in relation to guitar amplifiers such as a 13-pin connector or a phono-connector or headphone-type jack. In some embodiments, the wireless device is configured to output an analog audio signal which has been converted from received digital information from the wireless communication module 6 of a circuit 211 of a guitar 1. Accordingly, the wireless device may include a digital-to-analog converter. The analog audio signal may be output by the wireless device through its connector.

In embodiments, as mentioned above, the wireless device may be the external device 101. In embodiments, the functionality of the wireless device is achieved by the external device 101 which is coupled in electrical communication to the circuit 211 through the connector 223. As such, in embodiments, the external device 101 may be another device which is not capable of wireless communication or which is not wirelessly connected to the circuit 211.

In embodiments, the device 2 is configured to receive a computer program from the external device 101 using the wireless communication module 6 or through the connector 223. The computer program may be stored in the one or more memory elements 4. The computer program may then be loaded by the processor 3 from the or more memory elements 4 and run by the processor 3 (loading of the computer program may, of course, comprise the loading of a part of the computer program).

In embodiments, the one or more memory elements 4 include one or more volatile and one or more non-volatile memory elements. In embodiments, a computer program received from the external device 101 is stored in the one or more volatile memory elements. In embodiments, the computer program is stored in the one or more non-volatile memory elements.

In embodiments, the computer program is a self-contained computer program which provides complete instructions for the operation of the circuit 211. In other embodiments, the computer program is configured to call one or more functions (or firmware programs, for example) which are already stored in one or more of the or each memory elements 4. Such functions or firmware programs may be, for example, fundamental programs for the operation of the device 2—which might include control routines for the motors 213 and other elements of the device 2.

In embodiments, the computer program is an update or replacement version of the fundamental programs.

In embodiments, the device 2 is configured to output, via the wireless communication module 6 or connector 223, a digital signal which is representative of the vibrations of one or more strings 13 of the guitar 1. In other words, the digital signal may be an audio output from the guitar 1.

The external device 101 (wireless or otherwise), in embodiments, is configured to receive the digital signal representative of the vibrations of one or more strings 13 and to perform one or more functions in relation to the signal. For example, if the external device 101 is a dongle, then the digital signal may be re-transmitted by the external device 101 to yet another device—such as a personal computer.

In embodiments, the external device 101 (wireless or otherwise) may perform one or more transformations on the received digital signal. For example, the external device 101 may apply an “effect” to the digital signal. Effects which are commonly used in relation to guitar music and which may be applied to the digital signal by the external device 101 include a chorus effect, a flange effect, a phaser effect, a distortion effect, a pitch-shift effect, a reverb effect, a delay effect, and an overdrive effect. The external device 101 may re-transmit the transformed signal to another device—such as a speaker, an amplifier, a personal computer, or the like. Accordingly, the external device 101 may include one or more models which represent one or more such effects and which are used in the transformation of the received digital signal. The external device 101 may output the transformed digital signal in an analog form.

As will be appreciated, therefore, the external device 101 may be connected to a basic amplifier 102 (which does not, itself, have any such effects) and then used to apply one or more effects to the audio output from the guitar 1.

The external device 101 may also be communicatively coupled to a personal computer 103 (in addition to the circuit 211 of a guitar 1). The personal computer 103 may be configured to run one or more programs which a user can operate to control one or more aspects of the external device 101—such as the effect or effects which are applied to a received digital signal from the guitar 1 (see above). In embodiments, the personal computer 103 applies the effects. In embodiments, the personal computer 103 is a computing device which is located in a pedal or other actuator which a user can operate to select, for example, an effect or effects to be applied to the digital signal. In embodiments, the personal computer 103 is coupled to a pedal or other actuator which a user can operate to control the personal computer 103 to perform such functions.

In embodiments, the analog audio output 19 of the guitar 1 is connected by a cable to the connector 223. This connection (as part of a module in the cable or otherwise) may include an analog to digital converter. In embodiments, the digital equivalent of this analog audio output signal is made available to the circuit 211 of the guitar 1 for use thereby. In embodiments, an external device 101 is provided which includes a coupling to the analog audio output 19 of the guitar 1. This external device 101 may be coupled to the connector 223 and may include an analog to digital converter. The external device 101 may be configured to transmit a digital representation of the analog audio signal to the circuit 211 and/or to another device (such as another external device 101) wirelessly through a wireless communication module of the external device 101 (as such the external device 101 may be a wireless communication module device 100 couplable to the connector 223).

Accordingly, as will be appreciated, the device 2 may be communicatively coupled to one or more external devices 101 (which may include other guitars 1). The operation of the device 2 may be controlled, at least in part, by the one or more communicatively coupled external devices 101, and the output of the device 2 may be processed (and potentially altered) by the one or more communicatively coupled external devices 101.

In embodiments, as mentioned above, a computer program may be downloaded to the device 2 and stored in the or more memory elements 4 of the circuit 211.

In embodiments, therefore, such a computer program may be downloaded to the device 2 by an external device 101 in the form of a personal computer 103. The personal computer 103 may be communicatively coupled to a network 104 such as the Internet (or a local area network or wide area network). The personal computer 103 may be communicatively coupled, via the network 104 or otherwise, to a catalogue 105 of computer programs.

The catalogue 105 of computer programs may include computer programs which can control the device 2 in a number of different ways. For example, the catalogue 105 of computer programs may include different tuning configurations for the strings 13 of the guitar 1 which may be used by the device 2 to tune the strings 13 to particular notes. The catalogue 105 of computer programs may include one or more effects which the device 2 can apply to the signals received from the or each pick-up 18, 22—such as the effects discussed above—before the transformed signals are output as digital signals from the device 2 to an external device 101.

The catalogue 105 of computer programs may include one or more programs which are configured to monitor the outputs from the or each pick-up 18,22 and to compare this output with an ideal or predetermined output for a particular piece of music—accordingly, the computer program may identify playing errors. The computer program may, through the display screen 222 (or via an external device 101 connected to the device 2) provide feedback on errors—which may include the mere notification that an error has occurred, a score based on the number and severity of errors (for example), and/or hints or tips on how to improve the playing of the piece of music.

The catalogue 105 of computer programs may include computer programs which allow collaborative works to be created by remote players using similar devices 2. Accordingly, the computer programs on multiple devices 2 may communicate with each other in order to provide one device 2 with information regarding the notes being played on another device 2 or the current tuning configuration of another device 2. The devices 2 may interact with each other to coordinate tuning configurations—to ensure that all of the instruments are in tune with each other and/or to alter the tuning configurations of the instruments in a synchronised manner (e.g. during the playing of a collaborative piece of music).

The catalogue 105 of computer programs may include one or more games which can be played by multiple users with respective devices 2. Accordingly, two users may be provided with a sequence of notes or chords to play and the game may score each user based on the accuracy of their playing of the notes and/or chords.

In embodiments, the catalogue 105 of computer programs may include one or more tutorial computer programs. An example tutorial computer program, when downloaded to the device 2, may cause the device 2 to interact with a communicatively coupled external device 101. The external device 101 may include a display screen which outputs, for example, a graphical representation of the neck of a guitar (including a fret board). The graphical representation may include an indication of finger placement on the fret board 121 for the user to achieve the desired note or chord. The device 2 may monitor the signals received from the or each pick-up 18,22 to determine whether the user has achieved the correct finger locations. Based on this monitoring, the device 2 may cause the display screen to depict an indication of whether or not the user achieved the required finger locations and/or an indication of the actual finger locations of the user—actual finger locations may be displayed along side or overlaid with a representation of the correct finger locations. The computer program may cause a sequence of such operations to occur. As will be appreciated, the computer program which is downloaded to the device 2 may have a counterpart computer program which is provided to the external device 101. The counterpart computer program may be provided to the external device 101 directly from, for example, the catalogue 105 or may be provided to the external device 101 by the device 2.

The catalogue 105 of computer programs may include a configuration computer program which allows a user to operate an external device 101 to configure their device 2—for example, setting new tuning configurations and the like. In embodiments, a computer program may allow a user to select a new pre-defined tuning configuration on the pressing of a user input button 224,224a or the actuation of an external device 101 (such as a pedal) communicatively connected to the device 2. The computer program may allow a user to select a new pre-defined tuning configuration at a specific point in a piece of music which the device 2 is able to detect based on one or more notes or chords which are detected by the device 2 during a monitoring period. Accordingly, the tuning configuration of the guitar 1 may be altered during a piece of music.

A computer program may also, for example, automatically select a different tuning configuration if a broken string 13 is detected or some other fault occurs—such that the user can continue a piece of music without the need to change guitars 1 or replace the string 13 before continuing.

As will be appreciated, other computer programs in the catalogue 105 may include computer programs which include a first part for the device 2 and a second part of an external device 101—the two parts may communicate with each other in the operation of the computer program and such communication may be over a wireless communication link (as discussed above in relation to, for example, the wireless communication module 6) or a wired communication link (as discussed above in relation to certain embodiments using the connector 223).

In embodiments, the catalogue 105 of computer programs is operated as a store—in which each computer program may be purchased by a user and downloaded onto their external device 101 and then to the device 2.

Accordingly, in embodiments, the catalogue 105 may be communicatively coupled to a payment processing system 105a which is configured to process a payment from a user for the purchase of a computer program. The payment processing system 105a may be a web-based payment processing system 105a configured to accept credit card payments and the like.

The catalogue 105 of computer programs and/or the payment processing system 105a may include a user account record which is associated with a particular user and/or a particular device 2. The user account record may include username and password details (to allow the catalogue 105 and/or payment processing system 105a to verify the identity of a user attempting access the catalogue 105 and/or payment processing system 105a. The user account record may also include a record of computer programs which have been purchased from the catalogue 105 for that user and/or device 2. The user account record may also include a record of computer programs which have been downloaded from the catalogue 105 to the device 2 or which have been downloaded to the device 2 in relation to a particular user.

In embodiments, information from the device 2 may be output via the wireless communication module 6 and/or via a wired connection through the connector 223 to an external device 101 which is coupled to the network 104. This information may be passed to a diagnostics facility 106 which may include a computing device. The information may include operational information regarding the device 2 such as:
the number of tuning operations which have occurred,
the current state of the power supply 212 (and battery charge level if applicable),
the frequency of tuning operations,
error messages generated within the device 2,
the number of broken stings 13,
the time since the strings 13 were last changed,
the number of tune operations since the stings 13 were last changed,
the date of installation of the device 2,
other installation parameters,
self-test results, and/or
other historic usage data.

This information is then used by the diagnostics facility 106 to collate statistics regarding the use of one or more devices 2, to identify potential errors or faults, to generate a recommendation for the strings 13 to be changed, to generate a recommendation that the device 2 is serviced, handle warranty claims, and the like. As a result a message may be transmitted to the user—e.g. to recommend that the strings 13 are changed, that the device 2 is serviced, etc. The message may be sent to the device 2 for transmission to the user via the display screen 222 or via a screen of an external device 101 communicatively coupled to the device 2. The message may be sent to the external device 101 to which the device 2 is communicatively coupled. The message may be to the user via some other communication means (e.g. post, telephone, text message, email, etc) identified by the user during a product registration process. The product registration process may be an electronic communication process requiring the user to connect the device 2 to an external device 101 connected to the network 104 so that a registration facility (which may include a registration computing device) 107 can record information from the device 2 (such as a serial number associated with the device 2).

The device 2 may, accordingly, be associated with a serial number. The serial number may be stored in a memory element 4 of the device 2 and may be transmitted to a requesting external device 101 or other external service (such as the catalogue 105 of computer programs and/or the diagnostics facility 106.

In embodiments, a computer program from the catalogue 105 of computer programs may be downloaded to an external device 101 and copied from the external device 101 onto a portable storage medium 108 which is configured to connection to the connection 233 of the device 2. The device 2 may be configured, therefore, to download the computer program from the portable storage medium 108.

An embodiment of an external device 101 comprising an integrated amplifier and computing device 101a is shown in FIG. 15. The integrated device 101a comprises a housing 1011, one or more speakers 1012 (which may be covered by a mesh or decorative cover 1013), a graphical display screen 1014, and a plurality of controls 1015.

The housing 1011 may be provided in the form of a box with two hinged sections. The plurality of controls 1015 and graphical display screen 1014 may be provided within the box and only useable when the box is in an open configuration. The graphical display screen 1014 may be configured fold out from the confines of the box in order to hold the box in an open configuration.

The or each speaker 1012 may be provided in a lid part of the housing 1011 and configured to direct sound away from the housing 1011.

The housing 1011 may have the external appearance of a head or cartoon character.

The housing 1011, in the form of a box, may include one or more recesses or dishes which are available to hold one or more objects when the box is in the open configuration.

When in the closed configuration, the housing 1011 may hide and/or protect the graphical display screen 1014 and/or the plurality of controls 1015.

The plurality of controls 1015 may include controls for an amplifier circuit (not shown) which is housed in the integrated device 101a. These controls 1015 may include volume and tone controls, for example.

The housing 1011 may be provided with one or more mounting points for one or more carrying straps.

An input and/or output connector 1016 may be provided which is accessible when the housing 1011 is in the closed configuration.

The graphical display screen 1014 may include a processor and may, therefore, be a tablet-style computing device mounted in the housing 1011. The graphical display screen 1014 may include a connection (not shown) for connection to a power supply (such as a mains electrical supply). The power supply may be used to recharge a battery of the integrated device 101a. The connection for the power supply may be a port which is also configured to receive and transmit data such that the integrated device 101a can be communicatively coupled to one or more further devices (such as a portable storage medium or other computing device such as the device 2). More than one such connection may be provided.

In an embodiment, the or each connection is provided in the housing 1011 and may be a USB, micro-usb, or mini-usb connection (all Type A or Type B).

The graphical display screen 1014 may include a wireless communication module which is capable of communicating with a wireless communication module 6 of a device 2 of a guitar 1—such that the integrated device 101a may form an external device 101 as described above via this wireless communication link or via a wired communication link using the port described above.

A battery (not shown) may be provided within the housing 1011 and configured to power the amplifier circuit.

In embodiments, the device 2 is configured to be retrofitted to an existing electric or acoustic guitar 1. Accordingly, a method of fitting such a device 2 to an existing guitar 1 may include a step of selecting a device 2 which is configured for retrofitting to that existing guitar 1. As such one or more components of the device 2 may be configured (e.g. sized and shaped) to be received by an existing guitar body 11 without the need to remove additional material from the guitar body 11. The device 2 may also be of a comparable weight to the existing bridge of a guitar 1 and/or have comparable (i.e. compatible) fixtures to allow the device 2 to be coupled to the existing fixings of the guitar 1.

As used herein, a ‘personal computer’ (103 or otherwise) may include a desktop computer, a portable computer, a laptop computer, a notebook computer, a tablet computer, a mobile (i.e. ‘cellular’) telephone, a watch, or another other form of computing device.

The catalogue 105 of computer programs, the diagnostics facility 106, the payment processing system 105a, and the registration facility 107 may be provided by one or more servers.

As will be appreciated, the device 2 can tune the strings 13 of the guitar 1 according to a desired tuning configuration in accordance with a computer program. This may include, for example, a standard tuning configuration or the tuning of all or just some of the strings 13 of the guitar to a different tuning configuration.

In embodiments, the device 2 is configured to tune the strings 13 of the guitar 1+/−4 semitones. In embodiments, all of the strings 13 may be tuned substantially simultaneously. In embodiments, the strings 13 are tuned sequentially by the device 2. In embodiments, a plurality of strings 13 is tuned substantially simultaneously but sequentially with another one, or more, strings 13. In embodiments, therefore, tuning can occur in under 4 seconds to a 1% accuracy.

Embodiments of the device 2 may be configured for use with strings 13 of different gauges.

In embodiments, the device 2 includes a climate parameter detection system 9. The climate parameter detection system 9 is configured to determine one of more characteristic of the environment in which the guitar 1 is located. For example, the system 9 may determine the temperature and/or humidity of the environment in which the guitar 1 is located. When a tuning operation occurs, one or more climate parameters may be recorded by the system 9 and associated with that tuning operation. The client parameter detection system 9 may monitor changes in the environmental conditions which may impact the tuning of the guitar 1. If a change in one or more of the recorded parameters occurs, then the system 9 may provide an indication to the user (e.g. through the display screen 222 or string displays 222a) that a re-tune is required or advised. The system 9 may, in embodiments, determine the current tuned status of the guitar 1 by monitoring the signals output from the or each pick-up 18,22 to determine if the guitar 1 is, indeed, out of tune. The system 9 may defer any notification to the user until the guitar 1 is, indeed, out of tune. The system 9 may, in embodiments, trigger the automatic re-tuning of the guitar 1 without warning or notifying the user. In embodiments, a notification is provided to an external device 101. In embodiments, the system 9 is located in an external device 101.

In embodiments, the device 2 is configured to output information—to the display screen 222, string displays 22a, and/or an external device 101—to assist the user in making an intonation adjustment.

An external device 101 may include a computing device, an amplifier, an effects pedal, and the like—as will be appreciated.

In embodiments, no connector 223 is provided. In embodiments, the connector 223 is provided in the rear cover plate 2121a of the guitar 1 in addition to or instead of the elongate housing 221 of the pick-up 22.

In embodiments, the device 2 may use an operating system which may be Linux-based.

In embodiments, the device 2 can be connected to one or more proprietary “app-stores” which are examples of catalogues 105 of computer programs operated by a third party. Accordingly, the app-store may be an app-store operated by Apple, Inc, or Google, Inc. The device 2 may, therefore, be communicatively coupled to more than one catalogue 105 of computer programs.

In embodiments, the wireless communication module 6 is configured to communicate over a mobile (i.e. cellular) telephone network.

During a calibration process for the device 2, once fitted to a guitar 1, the device 2 may determine guitar 1 specific parameters associated with neck flex, structural resonance characteristics, and scale length for use in control routines within the device 2 during a tuning process.

In embodiments, the device 2 is configured to store ten or more predefined tuning configurations which may be selected by the user. In embodiments, the device 2 is configured to store ten or more factory set tuning configurations which may be selected by the user. In embodiments, the device 2 is configured to store ten or more user configurable tuning configurations which may be set by the user (in addition to or separate from the factory set tuning configurations). In an embodiment, the device 2 is configured to store then factory set tuning configurations and nine user configurable tuning configurations. A user may set a tuning configuration by tuning a guitar 1 (using the tuning pegs 14) to a desired tuning configuration, selecting a store function of the device 2, and strumming the strings 13. The device 2 then records information regarding the tuning configuration.

As mentioned above, a computer program for the device 2 may include a tuning configuration and/or one or more instructions for the operation of components of the device 2.

In embodiments, the device 2 is configured to output (via the connector 223 or wireless communication module 6, for example) real-time or substantially real-time information regarding the operation of the device 2 and the guitar 1 (including an audio output form the guitar 1 and/or information regarding the current tuning configuration of the guitar 1, for example). This information may be displayed by an external device 101 communicatively coupled to the device 2.

Although embodiments of the invention are described with reference to a guitar 1, it will be appreciated that embodiments of the present invention may be used with other instruments. Embodiments of the present invention may be used, for example, with stringed instruments.

FIG. 17 shows various components of a system in accordance with an embodiment of the present invention connected together in various different configurations. This figure is intended to provide a visual depiction of the possible connections which may be made between the components described herein. It will be appreciated that a system may not include all of these connections and that not all of the connections will (or, indeed, can) be active at any given time. Any one or more of the indicated connections may not be provided in a given system and any one or more of the depicted components may also be omitted from a given system. Any one or more of the connections may be wired or wireless. Other connections between the components may also be possible. As will be appreciated, each communication link will involve a communication interface of the respective components.

In embodiments, the drive and control circuit 211 may or may not be part of the automatic tuning mechanism 21.

The wireless communication module 6 and/or the connector 223 each comprise a respective communication interface of the device 2. It will be appreciated that only one or both (or other) communication interfaces may be provided in embodiments.

The serial number for the device 2 is an example of a substantially unique identifier for the device 2 which may be used for identification purposes—in relation to communication between the components of the system shown in FIG. 17, for example.

When used in this specification and claims, the terms “comprises” and “comprising” and variations thereof mean that the specified features, steps or integers are included. The terms are not to be interpreted to exclude the presence of other features, steps or components.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. An automatic tuning device for a musical instrument, the device comprising:
an automatic tuning mechanism which is configured to tune a musical instrument in accordance with a tuning configuration, wherein the mechanism includes:
a processor configured to execute a computer program,
a memory configured to store one or more computer programs for execution by the processor, and
a communication interface configured to receive one or more computer programs for storage in the memory, wherein the one or more computer programs include a computer program which, when executed by the processor, controls an aspect of the operation of the automatic tuning device.

2. A device according to claim 1, wherein the communication interface is a wireless communication interface.

3. A device according to claim 1, wherein the communication interface is a wired communication interface.

4. A device according to claim 3, wherein the wired communication interface is configured to couple communicatively the mechanism to an external device.

5. (canceled)

6. A device according to claim 1, wherein the one or more programs includes a tuning configuration.

7. A device according to claim 1, further comprising a pick-up which is configured to output a signal representative of the vibration of an associated string of the instrument.

8. A device according to claim 7, wherein the mechanism is configured to use the signal output by the pick-up in a tuning process.

9. A device according to claim 1, wherein the communication interface is configured to couple communicatively the mechanism to a catalogue of one or more computer programs, each of which is downloadable to the mechanism for storage in the memory.

10. A device according to claim 9, wherein the one or more computer programs of the catalogue of one or more computer programs include a collaborative computer program which is configured to allow collaborative works to be generated by multiple devices; and/or a tutorial computer program; and/or a game.

11. A device according to claim 1, wherein the communication interface is configured to receive one or more computer programs when the mechanism is in a fitted configuration with respect to the instrument.

12. A device according to claim 1, wherein the communication interface is configured to output information regarding the operation of the instrument.

13. A device according to claim 12, wherein the information includes one or more of real-time or substantially real-time information, an audio output signal for the instrument, historical usage information, and a substantially unique identifier for the device.

14. (canceled)

15. (canceled)

16. (canceled)

17. A system including:
an automatic tuning device for a musical instrument, the device comprising:
an automatic tuning mechanism which is configured to tune a musical instrument in accordance with a tuning configuration, wherein the mechanism includes:
a processor configured to execute a computer program,
a memory configured to store one or more computer programs for execution by the processor, and
a communication interface configured to receive one or more computer programs for storage in the memory, wherein the one or more computer programs include a computer program which, when executed by the processor, controls an aspect of the operation of the automatic tuning device; and
an external device which is communicatively coupled to the device by the communication interface.

18. A system according to claim 17, wherein the external device includes an amplifier.

19. A system according to claim 17, wherein the communication interface is configured to output a digital audio signal to the external device.

20. A system according to claim 19, wherein the external device is configured to receive the digital audio signal, transform the digital audio signal, and transmit the transformed digital audio signal to a further device.

21. A system according to claim 19, wherein the external device is configured to receive the digital audio signal, transform the digital audio signal, convert the transformed digital audio signal into an analog audio signal and transmit the analog audio signal to a further device.

22. A system according to claim 20, wherein the transformation of the digital audio signal includes the application of an audio effect.

23. A system according to claim 17, wherein the external device is a wireless communication module device.

24. A computer program distribution system comprising:
a catalogue of one or more computer programs;
an automatic tuning device for a musical instrument, the device comprising:
an automatic tuning mechanism which is configured to tune a musical instrument in accordance with a tuning configuration, wherein the mechanism includes:
a processor configured to execute a computer program,
a memory configured to store one or more computer programs for execution by the processor, and
a communication interface configured to receive one or more computer programs for storage in the memory, wherein the one or more computer programs include a computer program which, when executed by the processor, controls an aspect of the operation of the automatic tuning device; and
a communication interface configured to be communicatively coupled to the automatic tuning device, wherein the system is configured to transmit a computer program of the one or more computer programs to the automatic tuning device and the computer program, when executed by the processor of the device, controls an aspect of the operation of the automatic tuning device.

25. (canceled)

26. (canceled)

27. (canceled)
